(19) United States
(12) Patent Application Publication
(10) Pub. No.: US 2024/0329589 A1
(43) Pub. Date: Oct. 3, 2024

(54) IMAGE FORMING APPARATUS

(71) Applicant: FUJIFILM Business Corp., Tokyo (JP)

(72) Inventors: Daisuke TANAKA, Ebina-shi (JP); Haruyuki IDEURA, Ebina-shi (JP)

(73) Assignee: FUJIFILM Business Corp., Tokyo (JP)

(21) Appl. No.: 18/362,601

(22) Filed: Jul. 31, 2023

(30) Foreign Application Priority Data
Mar. 29, 2023 (JP) 2023-053737

(51) Int. Cl. G03G 15/00; G03G 15/16

(52) U.S. Cl. CPC G03G 15/757; G03G 15/1615

(57) ABSTRACT

An image forming apparatus includes: an image bearing member that rotates and that retains an image to be transferred onto a recording medium; a first driving unit that rotationally drives the image bearing member; a transfer member that rotates while facing the image bearing member and that transfers the image retained by the image bearing member onto the recording medium passing through a face-to-face section where the image bearing member and the transfer member face each other; a second driving unit that rotationally drives the transfer member; and a torque adjusting unit that changes a driving torque applied to the transfer member by the second driving unit in accordance with a position of the recording medium passing through the face-to-face section.

### CROSS-REFERENCE TO RELATED APPLICATIONS

This application is based on and claims priority under 35 USC 119 from Japanese Patent Application No. 2023-053737 filed Mar. 29, 2023.

### BACKGROUND

### (i) Technical Field

The present disclosure relates to image forming apparatuses.

### (ii) Related Art

Japanese Unexamined Patent Application Publication No. 2011-81181 discloses an image forming apparatus including a photoconductor drum that rotates at a first peripheral speed, a transfer roller that forms a transfer nip by being in pressure contact with the photoconductor drum, and a fixing section that rotates at a second peripheral speed higher than the first peripheral speed. In this image forming apparatus, the transfer roller is rotated at the first peripheral speed until the leading edge of a sheet reaches the transfer nip. When the leading edge of the sheet subsequently reaches the transfer nip, the transfer roller is rotated at a third peripheral speed that is higher than the first peripheral speed. Then, when the leading edge of the sheet reaches the fixing section, the transfer roller is rotated at the second peripheral speed.

### SUMMARY

When an image retained on an image bearing member is to be transferred onto a recording medium transported through a face-to-face section where the image bearing member and a transfer member that rotates while facing the image bearing member are disposed facing each other, a transport load of the recording medium at the face-to-face section may vary depending on the position of the recording medium passing through the face-to-face section. When the transport load of the recording medium at the face-to-face section varies, misregistration or distortion may sometimes occur in the image transferred onto the recording medium.

Aspects of non-limiting embodiments of the present disclosure relate to reducing an effect caused by a variation in the transport load of the recording medium at the face-to-face section between the image bearing member and the transfer member, as compared with a case where a driving torque of the transfer member is uniform regardless of the position of the recording medium passing through the face-to-face section.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus comprising: an image bearing member that rotates and that retains an image to be transferred onto a recording medium; a first driving unit that rotationally drives the image bearing member; a transfer member that rotates while facing the image bearing member and that transfers the image retained by the image bearing member onto the recording medium passing through a face-to-face section where the image bearing member and the transfer member face each other; a second driving unit that rotationally drives the transfer member; and a torque adjusting unit that changes a driving torque applied to the transfer member by the second driving unit in accordance with a position of the recording medium passing through the face-to-face section.

### BRIEF DESCRIPTION OF THE DRAWINGS

An exemplary embodiment of the present disclosure will be described in detail based on the following figures, wherein:

FIG. 1 illustrates an image forming apparatus according to an exemplary embodiment of the present disclosure;

FIG. 2 illustrates how a sheet is transported in the image forming apparatus according to this exemplary embodiment;

FIG. 3 illustrates how the sheet is transported in the image forming apparatus according to this exemplary embodiment;

FIG. 4 illustrates a variation in a transport load of a sheet at a second-transfer section; and

FIG. 5 illustrates a timing chart indicating a change in a driving torque of a second-transfer roller.

### DETAILED DESCRIPTION

An exemplary embodiment of the present disclosure will be described in detail below with reference to the appended drawings.

### Configuration of Image Forming Apparatus 1

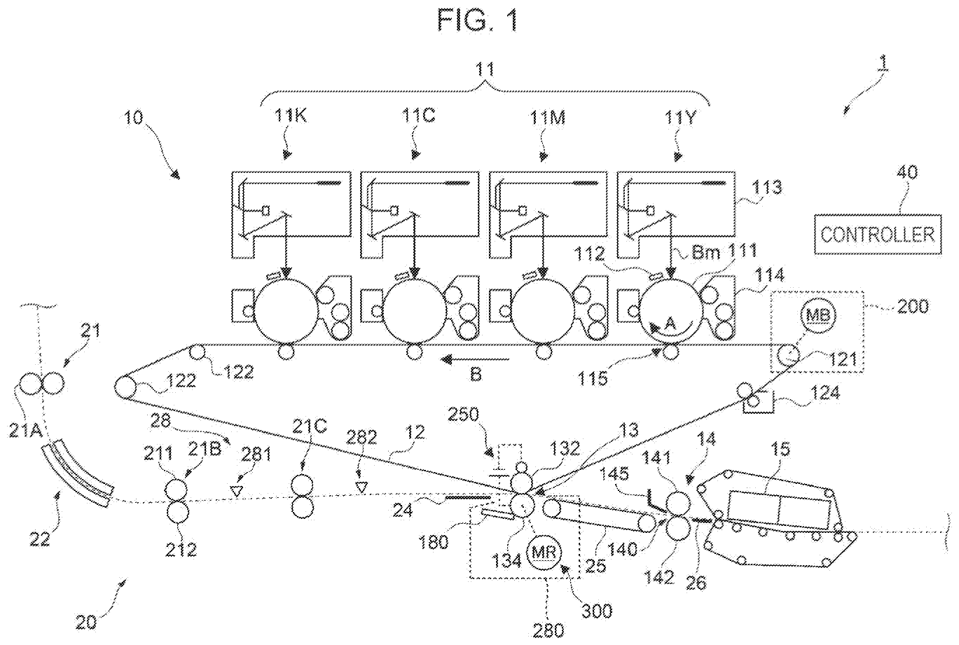

FIG. 1 illustrates an image forming apparatus 1 according to an exemplary embodiment of the present disclosure.

The image forming apparatus 1 according to this exemplary embodiment includes an image forming section 10, a sheet transport section 20, and a controller 40.

The image forming section 10 includes multiple image forming units 11 (11Y, 11M, 11C, and 11K), an intermediate transfer belt 12, a second-transfer section 13, a fixing device 14, and a cooling device 15.

In this exemplary embodiment, the image forming units 11 provided include four image forming units 11Y, 11M, 11C, and 11K respectively corresponding to four colors, namely, yellow (Y), magenta (M), cyan (C), and black (K).

The four image forming units 11 are arranged in the moving direction of the intermediate transfer belt 12. Each image forming unit 11 has a photoconductor drum 111, a charging device 112, an exposure device 113, and a developing device 114, and uses electrophotography to form an image formed of toner onto the intermediate transfer belt 12.

In other words, in this exemplary embodiment, the image forming units 11 form YMCK color images. Furthermore, in this exemplary embodiment, these formed images are transferred onto the intermediate transfer belt 12. Accordingly, the YMCK color images are formed on the intermediate transfer belt 12.

Each photoconductor drum 111 rotates at a predetermined speed in a direction indicated by an arrow A.

Each charging device 112 electrostatically charges the surface of the corresponding photoconductor drum 111. Moreover, each exposure device 113 radiates light onto the surface of the corresponding electrostatically-charged photoconductor drum 111.

Accordingly, an electrostatic latent image corresponding to an image to be formed is formed on the outer peripheral surface of the photoconductor drum 111.

Subsequently, each developing device 114 performs a developing process on the corresponding photoconductor drum 111, so as to form an image on the photoconductor drum 111. More specifically, the developing device 114 causes a developer to adhere to the surface of the photoconductor drum 111 having the electrostatic latent image formed thereon, so as to form an image on the surface of the photoconductor drum 111.

In the image forming units 11Y, 11M, 11C, and 11K, yellow, magenta, cyan, and black images are formed on the surfaces of the respective photoconductor drums 111.

The images formed on the photoconductor drums 111 are transferred (i.e., first-transferred) onto the intermediate transfer belt 12 at first-transfer sections 115.

Accordingly, a color image having multiple colors is formed on the intermediate transfer belt 12. In other words, the color image is temporarily retained by the intermediate transfer belt 12.

The intermediate transfer belt 12 as an example of an image bearing member is supported by multiple roller-shaped members 122.

Furthermore, this exemplary embodiment is provided with a belt driving mechanism 200 that rotationally drives the intermediate transfer belt 12.

The belt driving mechanism 200 as an example of a first driving unit drives and controls the intermediate transfer belt 12 such that the intermediate transfer belt 12 rotates at a predetermined fixed speed.

In other words, based on an output from, for example, a sensor that detects the rotational speed of the intermediate transfer belt 12, the belt driving mechanism 200 drives and controls the intermediate transfer belt 12 such that the intermediate transfer belt 12 rotates at the predetermined speed.

In this exemplary embodiment, the belt driving mechanism 200 includes a belt motor MB and a driving roller 121 that is disposed in contact with the inner peripheral surface of the intermediate transfer belt 12 and that is rotated by the belt motor MB. The belt driving mechanism 200 is also provided with a transmission unit (not shown) that includes a gear and that transmits a driving force from the belt motor MB to the driving roller 121.

Although details will be described later, the belt motor MB according to this exemplary embodiment is an outer rotor motor in which a rotor is disposed outward of a stator. Moreover, the belt motor MB according to this exemplary embodiment is a speed-controlled motor whose rotational speed is controllable by the controller 40.

The intermediate transfer belt 12 circulates in a direction indicated by an arrow B. In other words, the intermediate transfer belt 12 is rotated counterclockwise by the belt driving mechanism 200.

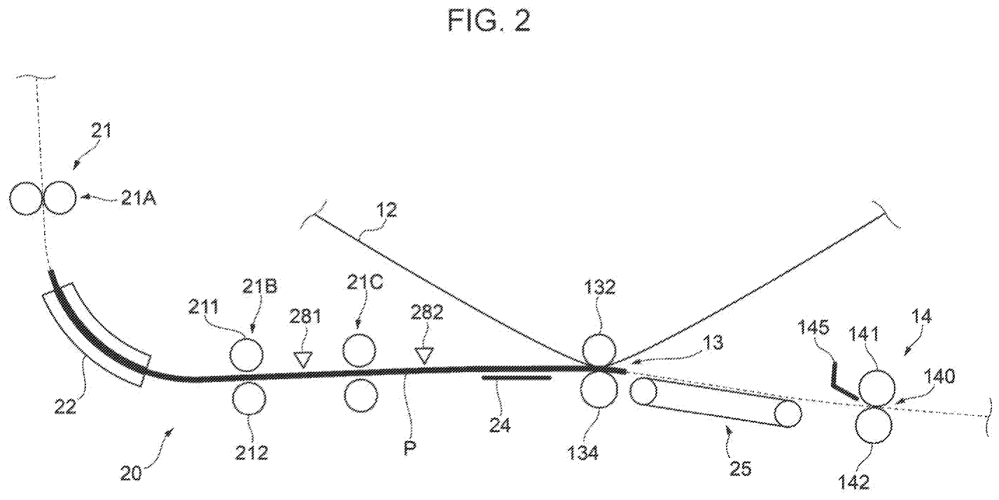

With the movement of the intermediate transfer belt 12, the image formed on the intermediate transfer belt 12 moves to the second-transfer section 13. Then, at the second-transfer section 13, the image moved to the second-transfer section 13 is transferred onto a sheet P (see FIG. 2) as an example of a recording medium transported by the sheet transport section 20.

The second-transfer section 13 is provided with a second-transfer roller 134 that is in contact with the outer peripheral surface of the intermediate transfer belt 12 and that is used for transferring the image on the intermediate transfer belt 12 onto the sheet P.

Furthermore, the second-transfer section 13 is provided with a backup roller 132 that is disposed within the intermediate transfer belt 12 and that serves as a counter electrode for the second-transfer roller 134.

In this exemplary embodiment, the second-transfer section 13 is an example of a face-to-face section where the intermediate transfer belt 12 and the second-transfer roller 134 face each other.

The backup roller 132 is disposed opposite from where the second-transfer roller 134 is installed with the intermediate transfer belt 12 interposed therebetween.

Furthermore, in this exemplary embodiment, the second-transfer roller 134 is pressed against the backup roller 132 with the intermediate transfer belt 12 interposed therebetween.

Moreover, this exemplary embodiment is provided with an application device 250 that applies voltage to the second-transfer roller 134 and the backup roller 132.

In this exemplary embodiment, the voltage applied by the application device 250 causes the image on the intermediate transfer belt 12 to be transferred onto the sheet P passing through between the second-transfer roller 134 and the backup roller 132.

Furthermore, this exemplary embodiment is provided with a cleaning blade 180 serving as a cleaning member that is pressed against the second-transfer roller 134 to clean the second-transfer roller 134.

The second-transfer roller 134 is movable toward and away from the intermediate transfer belt 12. Moreover, the second-transfer roller 134 is rotatable.

Furthermore, this exemplary embodiment is provided with a roller driving mechanism 300 as an example of a second driving unit. The roller driving mechanism 300 rotationally drives the second-transfer roller 134.

The roller driving mechanism 300 is provided with a roller motor MR and a transmission unit (not shown) that includes a gear and that transmits a driving force from the roller motor MR to the second-transfer roller 134.

The roller motor MR according to this exemplary embodiment is an inner rotor motor in which a rotor is disposed inward of a stator. Moreover, the roller motor MR according to this exemplary embodiment includes a rotation angle sensor (encoder) (not shown), and rotates the second-transfer roller 134 with a predetermined driving torque under the control of the controller 40. In other words, the roller motor MR according to this exemplary embodiment is a torque control motor capable of controlling the driving torque of the rotationally-driven second-transfer roller 134. In this exemplary embodiment, the operation of the roller motor MR is controlled in accordance with a pulse width modulation (PWM) control method. The control method of the roller motor MR is not particularly limited.

In the image forming apparatus 1 according to this exemplary embodiment, the peripheral speed of the second-transfer roller 134 is equal to the peripheral speed of the intermediate transfer belt 12 driven by the belt driving mechanism 200. The fact that the rotational speed of the second-transfer roller 134 and the peripheral speed of the intermediate transfer belt 12 are equal to each other implies that the moving speed of the outer peripheral surface of the rotating second-transfer roller 134 and the moving speed of the outer peripheral surface of the revolving intermediate transfer belt 12 are equal to each other at the second-transfer section 13 (i.e., at the face-to-face section between the second-transfer roller 134 and the intermediate transfer belt 12).

In this exemplary embodiment, the second-transfer roller 134 is rotated by being driven by the intermediate transfer belt 12 driven by the belt driving mechanism 200.

Furthermore, this exemplary embodiment is provided with a retraction mechanism 280 that moves the second-transfer roller 134 and the roller driving mechanism 300 away from the intermediate transfer belt 12 so as to retract the second-transfer roller 134 from the intermediate transfer belt 12. The retraction mechanism 280 is not particularly limited and is a known mechanism.

Moreover, this exemplary embodiment is provided with a belt cleaner 124 that is disposed downstream of the second-transfer section 13 in the moving direction of the intermediate transfer belt 12 and that cleans the outer peripheral surface of the intermediate transfer belt 12 after the second-transfer process.

The sheet transport section 20 is provided with multiple pairs of transport rollers 21 that transport the sheet P delivered from a sheet container (not shown). The multiple pairs of transport rollers 21 include a first pair of transport rollers 21A, a second pair of transport rollers 21B, and a third pair of transport rollers 21C that are disposed from upstream toward downstream in the transport direction of the sheet P. The second pair of transport rollers 21B and the third pair of transport rollers 21C are examples of transport units. The first pair of transport rollers 21A, the second pair of transport rollers 21B, and the third pair of transport rollers 21C will simply be referred to as pairs of transport rollers 21 if they are not to be distinguished from one another.

Each pair of transport rollers 21 includes a pair of drive roller 211 and counter roller 212 that face each other with the sheet P, delivered from the sheet container, interposed therebetween. The drive roller 211 and the counter roller 212 are rotatable. With regard to cach pair of transport rollers 21, the drive roller 211 is rotationally driven by a driving unit (not shown) in a state where the sheet P is nipped between the drive roller 211 and the counter roller 212, whereby the sheet P is transported toward the second-transfer section 13. Furthermore, in this exemplary embodiment, each of the second pair of transport rollers 21B and the third pair of transport rollers 21C is switchable between a contact state and a separated state under the control of the controller 40. In the contact state, the drive roller 211 and the counter roller 212 are in contact with each other with the sheet P nipped therebetween so as to be capable of transporting the sheet P. In the separated state, the drive roller 211 and the counter roller 212 are separated from each other so as not to transport the sheet P.

The sheet transport section 20 is provided with a guide member 22 that guides the sheet P, delivered from the sheet container and transported by the first pair of transport rollers 21A, in a bent state downstream in the transport direction. In other words, the guide member 22 is disposed between the first pair of transport rollers 21A and the second pair of transport rollers 21B.

The guide member 22 comes into contact with the sheet P transported by the first pair of transport rollers 21A and bends the sheet P such that the surface having the image formed thereon by the second-transfer section 13 faces inward. With the sheet P being bent by the guide member 22 in this exemplary embodiment, transport resistance may be reduced when the sheet P is transported by the pairs of transport rollers 21 even in a case where the sheet P has high rigidity, as in a cardboard.

The sheet transport section 20 is also provided with a transfer guide member 24 that guides the sheet P transported by the pairs of transport rollers 21 toward the second-transfer section 13. Furthermore, the sheet transport section 20 is provided with a transport belt 25 and a cooling guide member 26. The transport belt 25 transports the sheet P toward the fixing device 14 after the second-transfer process. The cooling guide member 26 guides the sheet P toward the cooling device 15 after the fixing process.

Moreover, the sheet transport section 20 is provided with a detector 28 that detects the position of the sheet P transported by the multiple pairs of transport rollers 21. The detector 28 includes a first sensor 281 that detects the sheet P transported between the second pair of transport rollers 21B and the third pair of transport rollers 21C, and a second sensor 282 that detects the sheet P transported between the third pair of transport rollers 21C and the transfer guide member 24.

The first sensor 281 and the second sensor 282 are, for example, infrared sensors and detect whether the leading edge or trailing edge of the transported sheet P has passed.

Furthermore, in this exemplary embodiment, the controller 40 acquires the position of the leading edge or trailing edge of the transported sheet P based on a time period elapsed from the timing at which the leading edge or trailing edge of the sheet P is detected by the first sensor 281 or the second sensor 282.

The fixing device 14 as an example of a fixing unit is disposed downstream of the second-transfer section 13 in the transport direction of the sheet P. The fixing device 14 includes a fixing roller 141 having a heating source (not shown) and a pressure roller 142 that is pressed against the fixing roller 141. The fixing roller 141 and the pressure roller 142 are an example of a pair of fixing members. The fixing device 14 includes a guide chute 145 that guides the sheet P toward a fixing section 140 formed between the fixing roller 141 and the pressure roller 142.

The sheet P that has passed through the second-transfer section 13 passes through the fixing section 140 formed between the fixing roller 141 and the pressure roller 142. Accordingly, the sheet P receives pressure and heat by being nipped between the fixing roller 141 and the pressure roller 142, whereby the image on the sheet P is fixed onto the sheet P. In this exemplary embodiment, the cooling device 15 is provided downstream of the fixing device 14. The cooling device 15 cools the sheet P transported from the fixing device 14.

The controller 40 includes a central processing unit (CPU), a read-only memory (ROM), a random access memory (RAM), and a hard disk drive (HDD) (none of which is shown). The CPU executes a processing program. The ROM and the HDD store, for example, various programs, various tables, and parameters. The RAM is used as, for example, a work area when the CPU executes the processing program.

The controller 40 as an example of a torque adjusting unit transmits signals for actuating the belt motor MB of the belt driving mechanism 200 and the roller motor MR of the roller driving mechanism 300 to the belt driving mechanism 200 and the roller driving mechanism 300 based on various programs or an operation input by the user. In detail, the controller 40 transmits a signal for designating the rotational speed of the belt motor MB to the belt driving mechanism 200. The controller 40 transmits a signal for designating the driving torque of the roller motor MR to the roller driving mechanism 300.

### Transportation of Sheet P

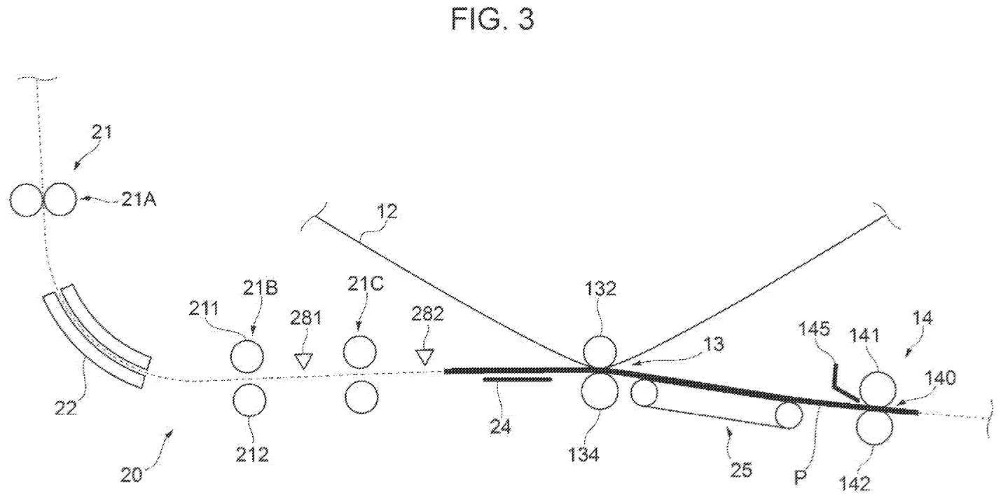

The following description relates to how the sheet P is transported in the image forming apparatus 1. FIGS. 2 and 3 illustrate how the sheet P is transported in the image forming apparatus 1 according to this exemplary embodiment.

When image forming operation commences under the control of the controller 40, the sheet P contained in the sheet container (not shown) is retrieved as toner images of the respective colors are formed at the image forming units 11. Then, the sheet P is transported toward the second-transfer section 13 by the pairs of transport rollers 21 in accordance with the timing at which the toner images on the intermediate transfer belt 12 are moved to the second-transfer section 13. In this case, each pair of transport rollers 21 is in the contact state where the drive roller 211 and the counter roller 212 are in contact with each other so as to be capable of transporting the sheet P.

When the sheet P is transported by the first pair of transport rollers 21A and reaches the guide member 22, the sheet P is transported further downstream in the transport direction by the first pair of transport rollers 21A while being bent by the guide member 22. When the leading edge of the sheet P reaches the second pair of transport rollers 21B and the third pair of transport rollers 21C and the trailing edge passes through the first pair of transport rollers 21A, the sheet P is transported further downstream in the transport direction by the second pair of transport rollers 21B and the third pair of transport rollers 21C.

Subsequently, as shown in FIG. 2, when the leading edge of the sheet P reaches the second-transfer section 13 where the intermediate transfer belt 12 and the second-transfer roller 134 face each other, the sheet P is transported further downstream in the transport direction by the revolving intermediate transfer belt 12 and the second-transfer roller 134 rotated by being driven by the intermediate transfer belt 12. When the leading edge of the sheet P reaches the second-transfer section 13, the second pair of transport rollers 21B and the third pair of transport rollers 21C are switched from the contact state to the separated state where they do not transport the sheet P.

When the leading edge of the sheet P transported by the intermediate transfer belt 12 and the second-transfer roller 134 reaches the transport belt 25, the sheet P is transported further downstream in the transport direction by the intermediate transfer belt 12, the second-transfer roller 134, and the transport belt 25.

Subsequently, as shown in FIG. 3, when the leading edge of the sheet P reaches the fixing section 140 of the fixing device 14, the sheet P is transported further downstream in the transport direction while receiving pressure and heat from the fixing roller 141 and the pressure roller 142. Although details will be described later, in the image forming apparatus 1 (see FIG. 1) according to this exemplary embodiment, the sheet P enters the fixing section 140 after the leading edge comes into contact with the guide chute 145, so as to be nipped between the fixing roller 141 and the pressure roller 142.

Then, the sheet P that has passed through the fixing section 140 of the fixing device 14 is transported further downstream in the transport direction, is cooled by the cooling device 15 (see FIG. 1), and is subsequently discharged outward from the image forming apparatus 1.

As mentioned above, the image forming apparatus 1 according to this exemplary embodiment performs image forming operation on the sheet P by transferring the image retained by the intermediate transfer belt 12 onto the sheet P by using the second-transfer roller 134 at the second-transfer section 13.

In the image forming apparatus 1, a transport load of the sheet P at the second-transfer section 13 may vary depending on the position of the sheet P passing through the second-transfer section 13 where the intermediate transfer belt 12 and the second-transfer roller 134 face each other. The transport load of the sheet P at the second-transfer section 13 corresponds to a load torque occurring between the sheet P and the intermediate transfer belt 12 at the second-transfer section 13.

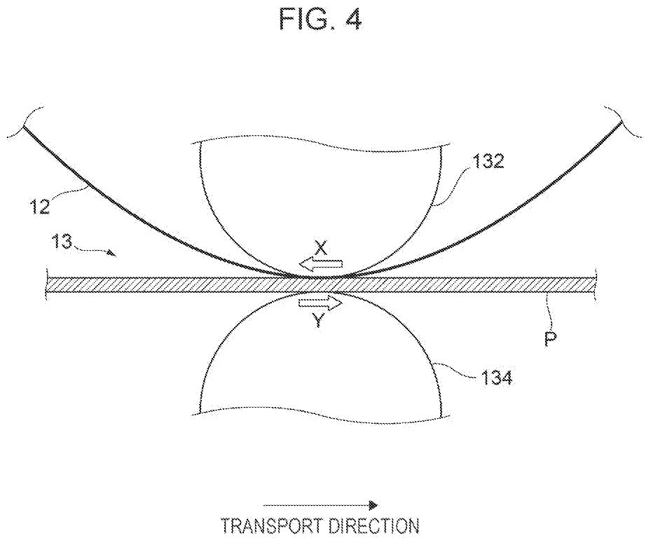

FIG. 4 illustrates how the transport load of the sheet P at the second-transfer section 13 varies.

As mentioned above, the guide member 22 (see FIG. 2) comes into contact with the sheet P to guide the sheet P in a bent state. When the sheet P is in contact with the guide member 22, a frictional force between the sheet P and the guide member 22 causes stress (i.e., stress acting upstream in the transport direction) to occur in the transported sheet P in a direction that hinders the transportation of the sheet P.

The following description relates to a conceivable case where the length of the sheet P in the transport direction is greater than the length from the guide member 22 to the second-transfer section 13 in the image forming apparatus 1. In this case, as shown in FIG. 2, the leading edge of the sheet P reaches the second-transfer section 13 in a state where the trailing edge of the sheet P is in contact with and is guided by the guide member 22, and the second pair of transport rollers 21B and the third pair of transport rollers 21C are switched to the separated state. Then, stress occurring as a result of the trailing edge of the sheet P coming into contact with the guide member 22 is transmitted to the second-transfer section 13 that transports the sheet P. As indicated by an arrow X in FIG. 4, stress acting upstream in the transport direction of the sheet P occurs at the second-transfer section 13, so that the transport load of the sheet P increases at the second-transfer section 13.

The following description relates to a conceivable case where the length of the sheet P in the transport direction is greater than the length from the second-transfer section 13 to the fixing section 140 of the fixing device 14 in the image forming apparatus 1. In this case, as shown in FIG. 3, in a state where the trailing edge of the sheet P is transported by the intermediate transfer belt 12 and the second-transfer roller 134 at the second-transfer section 13, the leading edge of the sheet P reaches the fixing section 140 of the fixing device 14 and receives pressure by being nipped between the fixing roller 141 and the pressure roller 142. Then, stress occurring in the direction that hinders the transportation of the sheet P as a result of the leading edge of the sheet P receiving pressure from the fixing roller 141 and the pressure roller 142 at the fixing section 140 is transmitted to the second-transfer section 13 that transports the sheet P. Similar to the above example, stress acting upstream in the transport direction occurs in the sheet P at the second-transfer section 13, as indicated by the arrow X in FIG. 4, so that the transport load of the sheet P increases at the second-transfer section 13.

When the transport load of the sheet P at the second-transfer section 13 varies, a slippage may sometimes occur between the sheet P and the outer peripheral surface of the intermediate transfer belt 12 or between the outer peripheral surface of the intermediate transfer belt 12 and the outer peripheral surface of the second-transfer roller 134 at the second-transfer section 13. If a slippage occurs between the sheet P and the surface of the intermediate transfer belt 12 at the second-transfer section 13, linear distortion extending in the width direction of the sheet P may possibly occur in the image transferred on the sheet P. A slippage occurring between the surface of the intermediate transfer belt 12 and the surface of the second-transfer roller 134 at the second-transfer section 13 may possibly lead to so-called color misregistration where the toner images transferred on the sheet P are positionally misaligned.

### Control of Driving Torque of Second-Transfer Roller 134

In contrast, in the image forming apparatus 1 according to this exemplary embodiment, the controller 40 changes the driving condition for the roller motor MR in the roller driving mechanism 300 in accordance with the position of the transported sheet P, and controls the driving torque of the second-transfer roller 134 rotationally driven by the roller motor MR. More specifically, depending on the position of the transported sheet P, the controller 40 increases the driving torque of the second-transfer roller 134 in accordance with the timing at which the transport load of the sheet P at the second-transfer section 13 increases.

In FIG. 4, an amount of increase in the driving torque of the second-transfer roller 134 is indicated by an arrow Y. In the image forming apparatus 1 according to this exemplary embodiment, a variation occurring in the transport load of the sheet P at the second-transfer section 13 is counterbalanced by controlling the driving torque of the second-transfer roller 134, thereby reducing an effect caused by the variation in the transport load of the sheet P at the second-transfer section 13.

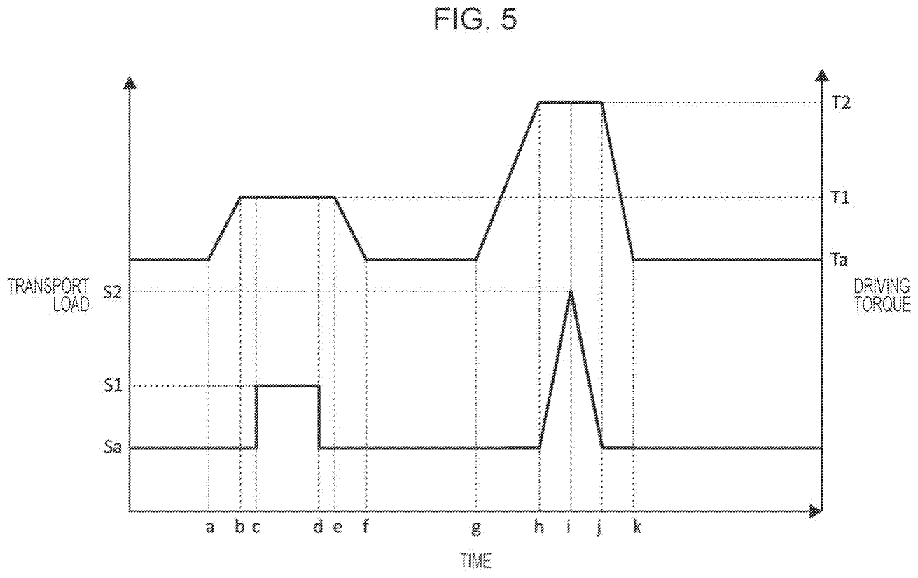

FIG. 5 is a timing chart illustrating a change in the driving torque of the second-transfer roller 134. FIG. 5 also illustrates a change in the transport load of the sheet P at the second-transfer section 13 in addition to the change in the driving torque of the second-transfer roller 134.

The abscissa axis in FIG. 5 denotes time that elapses from left to right. In other words, in FIG. 5, time elapses in the order of alphabetical signs (a, b, c, and so on) indicated on the abscissa axis. The ordinate axis in FIG. 5 denotes the driving torque of the second-transfer roller 134 and the transport load of the sheet P at the second-transfer section 13.

In the image forming apparatus 1 according to this exemplary embodiment, when image forming operation commences, the controller 40 controls the operation of the belt motor MB of the belt driving mechanism 200 and the operation of the roller motor MR of the roller driving mechanism 300 based on a predetermined driving condition. Accordingly, the intermediate transfer belt 12 driven by the belt driving mechanism 200 and the second-transfer roller 134 driven by the intermediate transfer belt 12 each rotate at a predetermined peripheral speed. Moreover, the roller motor MR serving as a torque control motor controls the driving torque of the second-transfer roller 134 to a predetermined reference torque Ta.

First, a change in the transport load of the sheet P at the second-transfer section 13 will be described.

As shown in FIG. 5, after the sheet P enters the second-transfer section 13 at a time point a, the transport load of the sheet P at the second-transfer section 13 increases at a time point c when the second pair of transport rollers 21B and the third pair of transport rollers 21C are switched from the contact state to the separated state. In the following description, the transport load of the sheet P at the time point a will be indicated as a reference load Sa, and the transport load of the sheet P at the time point c will be indicated as a first load S1. Specifically. the transport load of the sheet P at the second-transfer section 13 increases from the reference load Sa to the first load S1 at the time point c.

Subsequently, the transport load of the sheet P at the second-transfer section 13 decreases from the first load S1 to the reference load Sa at a time point d when the trailing edge of the sheet P passes the guide member 22. In other words, at the time point d, there is no frictional force occurring as a result of the sheet P and the guide member 22 coming into contact with each other, so that the transport load of the sheet P at the second-transfer section 13 decreases from the first load S1 to the reference load Sa.

Subsequently, the transport load of the sheet P at the second-transfer section 13 increases from the reference load Sa to a second load S2 at a time point i when the leading edge of the sheet P enters the fixing section 140 of the fixing device 14 and is nipped between the fixing roller 141 and the pressure roller 142 in a state where the trailing edge of the sheet P is passing through the second-transfer section 13. The second load S2 is greater than the reference load Sa and the first load S1. As shown in FIG. 5, the transport load of the sheet P at the second-transfer section 13 increases to the second load S2 at the time point i and subsequently decreases to the reference load Sa at a time point j when the leading edge of the sheet P has passed through the fixing section 140.

Next, a change in the driving torque of the second-transfer roller 134 will be described. As mentioned above, in the image forming apparatus 1 according to this exemplary embodiment, the controller 40 controls the driving torque of the second-transfer roller 134 by changing the driving condition (i.e., a PWM value) for the roller motor MR in the roller driving mechanism 300 that drives the second-transfer roller 134.

The controller 40 sets the driving torque of the second-transfer roller 134 to a first torque T1 greater than the reference torque Ta at the time point c when the transport load of the sheet P at the second-transfer section 13 increases from the reference load Sa to the first load S1.

In this exemplary embodiment, the controller 40 gradually increases the driving torque of the second-transfer roller 134 from the reference torque Ta at the time point a when the leading edge of the sheet P enters the second-transfer section 13. Then, the controller 40 controls the driving torque of the second-transfer roller 134 to the first torque T1 at a time point b that is prior to the time point c when the transport load of the sheet P at the second-transfer section 13 increases from the reference load Sa to the first load S1. In other words, the controller 40 gradually increases the driving torque of the second-transfer roller 134 from when the leading edge of the sheet P enters the second-transfer section 13 to when the second pair of transport rollers 21B and the third pair of transport rollers 21C subsequently stop transporting the sheet P.

Subsequently, the controller 40 decreases the driving torque of the second-transfer roller 134 to the reference torque Ta at a time point f that is subsequent to the time point d when the transport load of the sheet P at the second-transfer section 13 decreases from the first load S1 to the reference load Sa.

In this exemplary embodiment, the controller 40 gradually decreases the driving torque of the second-transfer roller 134 from the first torque T1 at a time point e that is subsequent to the time point d when the transport load of the sheet P at the second-transfer section 13 decreases to the reference load Sa. Then, the controller 40 controls the driving torque of the second-transfer roller 134 to the reference torque Ta at the time point f that is prior to a time point g when the leading edge of the sheet P comes into contact with the guide chute 145 of the fixing device 14. In other words, the controller 40 decreases the driving torque of the second-transfer roller 134 after the trailing edge of the sheet P passes the guide member 22.

In this example, the time (i.e., the time from the time point a to the time point b) it takes to increase the driving torque of the second-transfer roller 134 from the reference torque Ta to the first torque T1 is equal to the time (i.e., the time from the time point e to the time point f) it takes to decrease the driving torque of the second-transfer roller 134 from the first torque T1 to the reference torque Ta.

Subsequently, the controller 40 sets the driving torque of the second-transfer roller 134 to a second torque T2 greater than the reference torque Ta at the time point i when the transport load of the sheet P at the second-transfer section 13 increases from the reference load Sa to the second load S2. In this example, the second torque T2 is greater than the first torque T1.

In this exemplary embodiment, the controller 40 gradually increases the driving torque of the second-transfer roller 134 from the reference torque Ta at the time point g when the leading edge of the sheet P comes into contact with the guide chute 145 of the fixing device 14. Then, the controller 40 controls the driving torque of the second-transfer roller 134 to the second torque T2 at a time point h that is prior to the time point i when the transport load of the sheet P at the second-transfer section 13 increases from the reference load Sa to the first load S1. In other words, the controller 40 gradually increases the driving torque of the second-transfer roller 134 from when the leading edge of the sheet P comes into contact with the guide chute 145 as an example of a fixation guide member to when the leading edge of the sheet P subsequently enters the fixing section 140.

Subsequently, the controller 40 decreases the driving torque of the second-transfer roller 134 to the reference torque Ta at a time point k that is subsequent to the time point j when the leading edge of the sheet P passes through the fixing section 140 and the transport load of the sheet P at the second-transfer section 13 decreases from the second load S2 to the reference load Sa. In this example, the controller 40 gradually decreases the driving torque of the second-transfer roller 134 from the second torque T2 at the time point j such that the driving torque of the second-transfer roller 134 is set to the reference torque Ta at the time point k. In other words, the controller 40 decreases the driving torque of the second-transfer roller 134 after the leading edge of the sheet P passes through the fixing section 140.

In this example, the time (i.e., the time from the time point j to the time point k) it takes to decrease the driving torque of the second-transfer roller 134 from the second torque T2 to the reference torque Ta is shorter than the time (i.e., the time from the time point g to the time point h) it takes to increase the driving torque of the second-transfer roller 134 from the reference torque Ta to the second torque T2.

As described above, in the image forming apparatus 1 according to this exemplary embodiment, the driving torque of the second-transfer roller 134 driven by the roller motor MR of the roller driving mechanism 300 is changed in accordance with the position of the sheet P passing through the second-transfer section 13. Accordingly, an effect caused by a variation in the transport load of the sheet P at the second-transfer section 13 may be reduced, as compared with a case where the driving torque of the second-transfer roller 134 is uniform regardless of the position of the sheet P passing through the second-transfer section 13. Specifically, by changing the driving torque of the second-transfer roller 134 in accordance with the position of the sheet P passing through the second-transfer section 13, the variation occurring in the transport load of the sheet P at the second-transfer section 13 in accordance with the position of the sheet P passing through the second-transfer section 13 may be counterbalanced with the driving torque. Accordingly, a slippage between the sheet P and the outer peripheral surface of the intermediate transfer belt 12 or between the outer peripheral surface of the intermediate transfer belt 12 and the outer peripheral surface of the second-transfer roller 134 due to the variation in the transport load of the sheet P at the second-transfer section 13 may be less likely to occur.

In particular, in the image forming apparatus 1 according to this exemplary embodiment, when the sheet P passing through the second-transfer section 13 comes into contact with another member upstream or downstream of the second-transfer section 13, the driving torque of the second-transfer roller 134 is set to be greater than that before the sheet P comes into contact with the member. Accordingly, an effect caused by a variation occurring in the transport load of the sheet P at the second-transfer section 13 due to the sheet P coming into contact with another member may be reduced.

In this example, the guide member 22 is an example of another member with which the sheet P passing through the second-transfer section 13 comes into contact upstream of the second-transfer section 13. The fixing roller 141 or the pressure roller 142 of the fixing device 14 is an example of another member with which the sheet P passing through the second-transfer section 13 comes into contact downstream of the second-transfer section 13.

In the image forming apparatus 1 according to this exemplary embodiment, when the second pair of transport rollers 21B and the third pair of transport rollers 21C are to stop transporting the sheet P if the sheet P is passing through the second-transfer section 13, the controller 40 sets the driving torque of the second-transfer roller 134 to be greater than the reference torque Ta. Accordingly, even when stress occurring as a result of the sheet P coming into contact with the guide member 22 upstream of the second pair of transport rollers 21B and the third pair of transport rollers 21C in the transport direction is transmitted to the second-transfer section 13 that transports the sheet P, an effect caused by a variation in the transport load of the sheet P at the second-transfer section 13 may be reduced.

Furthermore, in the image forming apparatus 1 according to this exemplary embodiment, the controller 40 sets the driving torque of the second-transfer roller 134 to be smaller than the first torque T1 after the trailing edge of the sheet P that has passed through the second-transfer section 13 passes the guide member 22. Accordingly, a situation where the driving torque of the second-transfer roller 134 becomes excessive relative to the transport load of the sheet P at the second-transfer section 13 may be suppressed, as compared with a case where the magnitude of the driving torque of the second-transfer roller 134 is maintained after the trailing edge of the sheet P that has passed through the second-transfer section 13 passes the guide member 22. As a result, a slippage between the sheet P and the outer peripheral surface of the intermediate transfer belt 12 or between the outer peripheral surface of the intermediate transfer belt 12 and the outer peripheral surface of the second-transfer roller 134 at the second-transfer section 13 may be less likely to occur.

In the image forming apparatus 1 according to this exemplary embodiment, the controller 40 sets the driving torque of the second-transfer roller 134 to be greater than the reference torque Ta when the leading edge of the sheet P that has passed through the second-transfer section 13 enters the fixing section 140 of the fixing device 14. Accordingly, an effect caused by a variation in the transport load of the sheet P at the second-transfer section 13 may be reduced even when the variation occurs in the transport load of the sheet P at the second-transfer section 13 due to the sheet P receiving pressure from the fixing roller 141 and the pressure roller 142 downstream of the second-transfer section 13 in the transport direction.

Furthermore, in the image forming apparatus 1 according to this exemplary embodiment, the controller 40 sets the driving torque of the second-transfer roller 134 to be smaller than the second torque T2 after the leading edge of the sheet P that has passed through the second-transfer section 13 passes through the fixing section 140 of the fixing device 14. Accordingly, a situation where the driving torque of the second-transfer roller 134 becomes excessive relative to the transport load of the sheet P at the second-transfer section 13 may be suppressed, as compared with a case where the magnitude of the driving torque of the second-transfer roller 134 is maintained after the leading edge of the sheet P that has passed through the second-transfer section 13 passes through the fixing section 140 of the fixing device 14. As a result, a slippage between the sheet P and the outer peripheral surface of the intermediate transfer belt 12 or between the outer peripheral surface of the intermediate transfer belt 12 and the outer peripheral surface of the second-transfer roller 134 at the second-transfer section 13 may be less likely to occur.

In the image forming apparatus 1 according to this exemplary embodiment, when the sheet P passing through the second-transfer section 13 comes into contact with another member upstream or downstream of the second-transfer section 13, the controller 40 gradually increases the driving torque of the second-transfer roller 134 as time elapses. Accordingly, a slippage occurring between the outer peripheral surface of the intermediate transfer belt 12 and the outer peripheral surface of the second-transfer roller 134 at the second-transfer section 13 due to a change in the driving torque of the second-transfer roller 134 may be suppressed, as compared with a case where, for example, the driving torque of the second-transfer roller 134 is increased at once at a timing when the sheet P passing through the second-transfer section 13 comes into contact with another member upstream or downstream of the second-transfer section 13.

As an alternative to the above example where the controller 40 increases the driving torque of the second-transfer roller 134 linearly as time elapses, the controller 40 may increase the driving torque of the second-transfer roller 134 in a stepwise fashion as time elapses. The same applies to a case where the driving torque of the second-transfer roller 134 is decreased.

As mentioned above, the roller motor MR of the roller driving mechanism 300 that rotationally drives the second-transfer roller 134 in this exemplary embodiment is a torque control motor capable of controlling the driving torque of the second-transfer roller 134.

In the image forming apparatus 1 according to this exemplary embodiment, the controller 40 may change the driving torque of the second-transfer roller 134 within a range in which the ratio of the peripheral speed of the second-transfer roller 134 to the peripheral speed of the intermediate transfer belt 12 driven by the belt motor MB of the belt driving mechanism 200 does not change. Accordingly, for example, a slippage between the outer peripheral surface of the intermediate transfer belt 12 and the outer peripheral surface of the second-transfer roller 134 may be suppressed, as compared with a case where the driving torque of the second-transfer roller 134 is changed such that the ratio of the peripheral speed of the second-transfer roller 134 to the peripheral speed of the intermediate transfer belt 12 is changed.

In this example, the peripheral speed of the second-transfer roller 134 and the peripheral speed of the intermediate transfer belt 12 are equal to each other. Accordingly, the controller 40 may change the driving torque of the second-transfer roller 134 while maintaining the state where the peripheral speed of the second-transfer roller 134 is equal to the peripheral speed of the intermediate transfer belt 12.

### First Torque T1 and Second Torque T2

The following description relates to the magnitude of the driving torque (first torque T1, second torque T2) of the second-transfer roller 134 that is changed in accordance with the position of the sheet P passing through the second-transfer section 13 in the image forming apparatus 1 according to this exemplary embodiment.

As mentioned above, in the image forming apparatus 1, an increase in the transport load of the sheet P at the second-transfer section 13 is counterbalanced by increasing the driving torque of the second-transfer roller 134, thereby reducing an effect caused by a variation in the transport load of the sheet P at the second-transfer section 13. Accordingly, the first torque T1 and the second torque T2 may each be set in accordance with an amount of increase occurring in the transport load of the sheet P at the second-transfer section 13.

The amount of increase in the transport load of the sheet P at the second-transfer section 13 due to the sheet P transported through the second-transfer section 13 coming into contact with another member (e.g., the guide member 22, the fixing roller 141, or the pressure roller 142) upstream or downstream of the second-transfer section 13 tends to increase with increasing basis weight of the sheet P.

Moreover, the amount of increase in the transport load of the sheet P at the second-transfer section 13 due to the sheet P transported through the second-transfer section 13 coming into contact with another member upstream or downstream of the second-transfer section 13 tends to increase with decreasing smoothness in the surface of the sheet P.

Furthermore, the amount of increase in the transport load of the sheet P at the second-transfer section 13 due to the sheet P transported through the second-transfer section 13 coming into contact with another member upstream or downstream of the second-transfer section 13 tends to increase with increasing amount of toner transferred onto the surface of the sheet P (i.e., increasing density of an image formed on the sheet P).

Moreover, the amount of increase in the transport load of the sheet P at the second-transfer section 13 due to the sheet P transported through the second-transfer section 13 coming into contact with another member upstream or downstream of the second-transfer section 13 tends to increase with increasing temperature or humidity in the environment in which the image forming apparatus 1 is installed.

The controller 40 according to this exemplary embodiment may set the first torque T1 and the second torque T2 based on at least one of the basis weight of the sheet P, the smoothness in the surface of the sheet P, the density of an image formed on the sheet P, and the temperature and the humidity in the environment in which the image forming apparatus 1 is installed. In other words, the controller 40 may increase the first torque T1 and the second torque T2 with increasing basis weight of the sheet P, increasing smoothness in the surface of the sheet P, increasing density of an image formed on the sheet P, and/or increasing temperature or humidity in the environment in which the image forming apparatus 1 is installed.

Accordingly, for example, the driving torque of the second-transfer roller 134 may be readily controlled in accordance with the amount of increase in the transport load of the sheet P at the second-transfer section 13, as compared with a case where the first torque T1 and the second torque T2 are uniform regardless of the aforementioned conditions. Consequently, a variation in the transport load of the sheet P at the second-transfer section 13 may be readily counterbalanced with the driving torque. As a result, a slippage between the sheet P and the outer peripheral surface of the intermediate transfer belt 12 or between the outer peripheral surface of the intermediate transfer belt 12 and the outer peripheral surface of the second-transfer roller 134 may be less likely to occur.

In the above example, control is performed to increase the driving torque of the second-transfer roller 134 both at the timing at which the sheet P enters the second-transfer section 13 and the pairs of transport rollers 21 (i.e., the second pair of transport rollers 21B and the third pair of transport rollers 21C) stop transporting the sheet P and at the timing at which the leading edge of the sheet P enters the fixing section 140. However, the example is not limited to this.

For example, when the length of the sheet P in the transport direction is smaller than the length from the guide member 22 to the second-transfer section 13, a variation in the transport load of the sheet P at the second-transfer section 13 due to the sheet P entering the second-transfer section 13 and the pairs of transport rollers 21 stopping the transportation of the sheet P is less likely to occur. In this case, the control for increasing the driving torque of the second-transfer roller 134 is not to be performed when the sheet P enters the second-transfer section 13 and the pairs of transport rollers 21 stop transporting the sheet P. The control for increasing the driving torque of the second-transfer roller 134 may be performed when the leading edge of the sheet P enters the fixing section 140.

Likewise, when the length of the sheet P in the transport direction is smaller than the length from the second-transfer section 13 to the fixing section 140 of the fixing device 14, a variation in the transport load of the sheet P at the second-transfer section 13 due to the leading edge of the sheet P entering the fixing section 140 is less likely to occur. In this case, the control for increasing the driving torque of the second-transfer roller 134 is not to be performed when the leading edge of the sheet P enters the fixing section 140. The control for increasing the driving torque of the second-transfer roller 134 may be performed when the sheet P enters the second-transfer section 13 and the pairs of transport rollers 21 stop transporting the sheet P.

In the above example, the control for changing the driving torque of the second-transfer roller 134 in accordance with a variation in the transport load of the sheet P at the second-transfer section 13 involves increasing the driving torque of the second-transfer roller 134. However, the example is not limited to this.

For example, if the transport load of the sheet P at the second-transfer section 13 decreases, control for decreasing the driving torque of the second-transfer roller 134 may be performed for counterbalancing the variation in the transport load of the sheet P at the second-transfer section 13 by controlling the driving torque of the second-transfer roller 134. Other Modes for Changing Driving Torque

In the above example, a case where the sheet P passing through the second-transfer section 13 comes into contact with another member upstream or downstream of the second-transfer section 13 is exemplified as a case where the transport load of the sheet P at the second-transfer section 13 varies in the image forming apparatus 1. However, a case where the transport load of the sheet P at the second-transfer section 13 varies in the image forming apparatus 1 is not limited to the case described above.

For example, if the transport speed of the sheet P by the pairs of transport rollers 21 of the sheet transport section 20 and the transport speed of the sheet P by the intermediate transfer belt 12 and the second-transfer roller 134 at the second-transfer section 13 are different from each other, the transport load of the sheet P transported through the second-transfer section 13 may vary depending on the position of the sheet P relative to the second-transfer section 13. The transport speed of the sheet P by the intermediate transfer belt 12 and the second-transfer roller 134 at the second-transfer section 13 may simply be indicated below as the transport speed of the sheet P at the second-transfer section 13. It is assumed that the second pair of transport rollers 21B and the third pair of transport rollers 21C of the sheet transport section 20 are not switched to the separated state and continuously transport the sheet P until the sheet P passes.

The following description relates to a case where the transport speed of the sheet P by the pairs of transport rollers 21 of the sheet transport section 20 is higher than the transport speed of the sheet P at the second-transfer section 13. In this case, when the leading edge of the sheet P transported by the pairs of transport rollers 21 (e.g., the third pair of transport rollers 21C) enters the second-transfer section 13, a difference between the transport speed by the pairs of transport rollers 21 and the transport speed at the second-transfer section 13 causes stress acting downstream in the transport direction to occur in the sheet P at the second-transfer section 13, unlike the example shown in FIG. 4. Accordingly, when the leading edge of the sheet P transported by the pairs of transport rollers 21 enters the second-transfer section 13, the transport load of the sheet P at the second-transfer section 13 decreases. More specifically, when the leading edge of the sheet P transported by the pairs of transport rollers 21 enters the second-transfer section 13, the transport load of the sheet P at the second-transfer section 13 becomes smaller than the reference load Sa (see FIG. 5) mentioned above.

Even when the transport load of the sheet P at the second-transfer section 13 decreases, a slippage tends to occur between the sheet P and the outer peripheral surface of the intermediate transfer belt 12 or between the outer peripheral surface of the intermediate transfer belt 12 and the outer peripheral surface of the second-transfer roller 134, similar to the above example.

The controller 40 decreases the driving torque of the second-transfer roller 134 at the time point when the leading edge of the sheet P enters the second-transfer section 13. More specifically, the controller 40 sets the driving torque of the second-transfer roller 134 to be smaller than the reference torque Ta at the time point when the leading edge of the sheet P transported by the pairs of transport rollers 21 (e.g., the third pair of transport rollers 21C) enters the second-transfer section 13.

Accordingly, when the transport speed of the sheet P by the pairs of transport rollers 21 of the sheet transport section 20 is higher than the transport speed of the sheet P at the second-transfer section 13, an effect caused by a variation occurring in the transport load of the sheet P at the second-transfer section 13 due to the leading edge of the sheet P transported by the pairs of transport rollers 21 entering the second-transfer section 13 may be reduced.

The following description relates to a case where the transport speed of the sheet P by the pairs of transport rollers 21 of the sheet transport section 20 is lower than the transport speed of the sheet P at the second-transfer section 13. In this case, when the leading edge of the sheet P transported by the pairs of transport rollers 21 (e.g., the third pair of transport rollers 21C) enters the second-transfer section 13, a difference between the transport speed by the pairs of transport rollers 21 and the transport speed at the second-transfer section 13 causes stress acting upstream in the transport direction to occur in the sheet P at the second-transfer section 13, similar to the example shown in FIG. 4. Accordingly, when the leading edge of the sheet P transported by the pairs of transport rollers 21 enters the second-transfer section 13, the transport load of the sheet P at the second-transfer section 13 increases. More specifically, when the leading edge of the sheet P transported by the pairs of transport rollers 21 enters the second-transfer section 13, the transport load of the sheet P at the second-transfer section 13 becomes greater than the reference load Sa (see FIG. 5) mentioned above.

The controller 40 increases the driving torque of the second-transfer roller 134 at the time point when the leading edge of the sheet P enters the second-transfer section 13. More specifically, the controller 40 sets the driving torque of the second-transfer roller 134 to be greater than the reference torque Ta at the time point when the leading edge of the sheet P transported by the pairs of transport rollers 21 (e.g., the third pair of transport rollers 21C) enters the second-transfer section 13.

Accordingly, when the transport speed of the sheet P by the pairs of transport rollers 21 of the sheet transport section 20 is lower than the transport speed of the sheet P at the second-transfer section 13, an effect caused by a variation occurring in the transport load of the sheet P at the second-transfer section 13 due to the leading edge of the sheet P transported by the pairs of transport rollers 21 entering the second-transfer section 13 may be reduced.

If the transport speed of the sheet P by the pairs of transport rollers 21 of the sheet transport section 20 is lower than the transport speed of the sheet P at the second-transfer section 13, when the leading edge of the sheet P enters the second-transfer section 13 and the trailing edge of the sheet P subsequently passes through the pairs of transport rollers 21 (i.e., the third pair of transport rollers 21C) and is no longer transported by the pairs of transport rollers 21, the transport load of the sheet P at the second-transfer section 13 may sometimes decrease.

Specifically, after the trailing edge of the sheet P passes through the pairs of transport rollers 21, the stress occurring in the sheet P and acting upstream in the transport direction due to the difference between the transport speed by the pairs of transport rollers 21 and the transport speed at the second-transfer section 13 ceases. Accordingly, the transport load of the sheet P at the second-transfer section 13 decreases.

The controller 40 decreases the driving torque of the second-transfer roller 134 at the time point when the trailing edge of the sheet P passes through the pairs of transport rollers 21 (i.e., the third pair of transport rollers 21C) after the leading edge of the sheet P enters the second-transfer section 13.

Accordingly, when the transport speed of the sheet P by the pairs of transport rollers 21 of the sheet transport section 20 is lower than the transport speed of the sheet P at the second-transfer section 13, an effect caused by a variation occurring in the transport load of the sheet P at the second-transfer section 13 due to the trailing edge of the sheet P passing through the pairs of transport rollers 21 may be reduced.

### Belt Motor MB and Roller Motor MR

The following description relates to the belt motor MB in the belt driving mechanism 200 and the roller motor MR in the roller driving mechanism 300.

As mentioned above, the belt motor MB in the belt driving mechanism 200 is an outer rotor motor in which the rotor is disposed outward of the stator. The belt motor MB being an outer rotor motor has larger moment of inertia than the roller motor MR. Furthermore, as mentioned above, the belt motor MB is a speed-controlled motor whose rotational speed is controllable by the controller 40.

In this exemplary embodiment, the belt motor MB is an outer rotor motor with larger moment of inertia than the roller motor MR, so that the rotational speed of the intermediate transfer belt 12 to be rotated by the belt motor MB may be made stable, as compared with a case where the belt motor MB is an inner rotor motor.

As mentioned above, in the second-transfer section 13 according to this exemplary embodiment, the second-transfer roller 134 rotates by being driven by the intermediate transfer belt 12 that rotates at a predetermined speed. Therefore, with the rotational speed of the intermediate transfer belt 12 being made stable by the belt motor MB, a variation in the transport speed of the sheet P at the second-transfer section 13 may be less likely to occur.

On the other hand, the roller motor MR in the roller driving mechanism 300 is an inner rotor motor in which the rotor is disposed inward of the stator. The roller motor MR being an inner rotor motor has a smaller-sized rotor and smaller moment of inertia than the belt motor MB. As mentioned above, the roller motor MR is a torque control motor whose driving torque is controllable by the controller 40.

In this exemplary embodiment, the roller motor MR is an inner rotor motor with smaller moment of inertia than the belt motor MB, so that the second-transfer roller 134 to be rotated by the roller motor MR may readily rotate by being driven by the intermediate transfer belt 12, as compared with a case where the roller motor MR is, for example, an outer rotor motor. Accordingly, a slippage may be less likely to occur between the outer peripheral surface of the intermediate transfer belt 12 and the outer peripheral surface of the second-transfer roller 134.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image forming apparatus comprising:
an image bearing member that rotates and that retains an image to be transferred onto a recording medium;
a first driving unit that rotationally drives the image bearing member;
a transfer member that rotates while facing the image bearing member and that transfers the image retained by the image bearing member onto the recording medium passing through a face-to-face section where the image bearing member and the transfer member face each other;
a second driving unit that rotationally drives the transfer member; and
a torque adjusting unit that changes a driving torque applied to the transfer member by the second driving unit in accordance with a position of the recording medium passing through the face-to-face section.
   (((2)))

The image forming apparatus according to (((1))),
wherein, when the recording medium passing through the face-to-face section comes into contact with a second member upstream or downstream of the face-to-face section, the torque adjusting unit sets the driving torque of the transfer member to be greater than the driving torque of the transfer member before the recording medium comes into contact with the second member.
   (((3)))

The image forming apparatus according to (((2))), further comprising:
a transport unit that transports the recording medium toward the face-to-face section and that stops transporting the recording medium after a leading edge of the recording medium reaches the face-to-face section; and
a guide member that comes into contact with the recording medium and that guides the recording medium in a bent state toward the transport unit,
wherein the torque adjusting unit increases the driving torque of the transfer member when the transport unit stops transporting the recording medium.
   (((4)))

The image forming apparatus according to (((3))),
wherein the torque adjusting unit gradually increases the driving torque of the transfer member from when the leading edge of the recording medium reaches the face-to-face section to when the transport unit subsequently stops transporting the recording medium.
   (((5)))

The image forming apparatus according to (((3))) or (((4))),
wherein the torque adjusting unit decreases the driving torque of the transfer member after a trailing edge of the recording medium passes the guide member.
   (((6)))

The image forming apparatus according to any one of (((2))) to (((5))), further comprising:
a fixing unit that includes a pair of fixing members rotating while facing each other and that fixes the image transferred by the transfer member onto the recording medium passing through a fixing section formed between the pair of fixing members,
wherein the torque adjusting unit increases the driving torque of the transfer member when a leading edge of the recording medium that has passed through the face-to-face section enters the fixing section.
   (((7)))

The image forming apparatus according to (((6))), further comprising:
a fixation guide member that guides the recording medium toward the fixing section of the fixing unit,
wherein the torque adjusting unit gradually increases the driving torque of the transfer member from when the leading edge of the recording medium comes into contact with the fixation guide member to when the leading edge of the recording medium subsequently enters the fixing section.
   (((8)))

The image forming apparatus according to (((6))) or (((7))),
wherein the torque adjusting unit decreases the driving torque of the transfer member after the leading edge of the recording medium passes through the fixing section.
   (((9)))

The image forming apparatus according to (((1))), further comprising:
a transport unit that transports the recording medium toward the face-to-face section,
wherein, if a transport speed of the recording medium by the transport unit and a transport speed of the recording medium by the face-to-face section are different from each other, the torque adjusting unit changes the driving torque applied to the transfer member by the second driving unit when a leading edge of the recording medium enters the face-to-face section.
   (((10)))

The image forming apparatus according to (((9))),
wherein, if the transport speed of the recording medium by the transport unit is higher than the transport speed of the recording medium by the face-to-face section, the torque adjusting unit decreases the driving torque applied to the transfer member by the second driving unit when the leading edge of the recording medium enters the face-to-face section.
   (((11)))

The image forming apparatus according to (((9))),
wherein, if the transport speed of the recording medium by the transport unit is lower than the transport speed of the recording medium by the face-to-face section, the torque adjusting unit increases the driving torque applied to the transfer member by the second driving unit when the leading edge of the recording medium enters the face-to-face section.
   (((12)))

The image forming apparatus according to (((11))),
wherein the torque adjusting unit decreases the driving torque applied to the transfer member by the second driving unit when a trailing edge of the recording medium passes through the transport unit after the leading edge of the recording medium enters the face-to-face section.
   (((13)))

The image forming apparatus according to any one of (((1))) to (((12))),
wherein the torque adjusting unit changes the driving torque of the transfer member in accordance with at least one of a basis weight of the recording medium, smoothness of a surface of the recording medium, a density of the image to be transferred onto the recording medium, an air temperature, and humidity.
   (((14)))

The image forming apparatus according to any one of (((1))) to (((13))),
wherein the torque adjusting unit changes the driving torque of the transfer member within a range in which a ratio of a peripheral speed of the transfer member to a peripheral speed of the image bearing member does not change.
   (((15)))

The image forming apparatus according to any one of (((1))) to 14))),
wherein the first driving unit includes an outer rotor motor, and
wherein the second driving unit includes an inner rotor motor having smaller moment of inertia than the first driving unit.

What is claimed is:

1. An image forming apparatus comprising:
an image bearing member that rotates and that retains an image to be transferred onto a recording medium;
a first driving unit that rotationally drives the image bearing member;
a transfer member that rotates while facing the image bearing member and that transfers the image retained by the image bearing member onto the recording medium passing through a face-to-face section where the image bearing member and the transfer member face each other;
a second driving unit that rotationally drives the transfer member; and
a torque adjusting unit that changes a driving torque applied to the transfer member by the second driving unit in accordance with a position of the recording medium passing through the face-to-face section.

2. The image forming apparatus according to claim 1,
wherein, when the recording medium passing through the face-to-face section comes into contact with a second member upstream or downstream of the face-to-face section, the torque adjusting unit sets the driving torque of the transfer member to be greater than the driving torque of the transfer member before the recording medium comes into contact with the second member.

3. The image forming apparatus according to claim 2, further comprising:
a transport unit that transports the recording medium toward the face-to-face section and that stops transporting the recording medium after a leading edge of the recording medium reaches the face-to-face section; and
a guide member that comes into contact with the recording medium and that guides the recording medium in a bent state toward the transport unit,
wherein the torque adjusting unit increases the driving torque of the transfer member when the transport unit stops transporting the recording medium.

4. The image forming apparatus according to claim 3,
wherein the torque adjusting unit gradually increases the driving torque of the transfer member from when the leading edge of the recording medium reaches the face-to-face section to when the transport unit subsequently stops transporting the recording medium.

5. The image forming apparatus according to claim 3,
wherein the torque adjusting unit decreases the driving torque of the transfer member after a trailing edge of the recording medium passes the guide member.

6. The image forming apparatus according to claim 4,
wherein the torque adjusting unit decreases the driving torque of the transfer member after a trailing edge of the recording medium passes the guide member.

7. The image forming apparatus according to claim 2, further comprising:
a fixing unit that includes a pair of fixing members rotating while facing each other and that fixes the image transferred by the transfer member onto the recording medium passing through a fixing section formed between the pair of fixing members,
wherein the torque adjusting unit increases the driving torque of the transfer member when a leading edge of the recording medium that has passed through the face-to-face section enters the fixing section.

8. The image forming apparatus according to claim 7, further comprising:
a fixation guide member that guides the recording medium toward the fixing section of the fixing unit,
wherein the torque adjusting unit gradually increases the driving torque of the transfer member from when the leading edge of the recording medium comes into contact with the fixation guide member to when the leading edge of the recording medium subsequently enters the fixing section.

9. The image forming apparatus according to claim 7,
wherein the torque adjusting unit decreases the driving torque of the transfer member after the leading edge of the recording medium passes through the fixing section.

10. The image forming apparatus according to claim 8,
wherein the torque adjusting unit decreases the driving torque of the transfer member after the leading edge of the recording medium passes through the fixing section.

11. The image forming apparatus according to claim 1, further comprising:
a transport unit that transports the recording medium toward the face-to-face section,
wherein, if a transport speed of the recording medium by the transport unit and a transport speed of the recording medium by the face-to-face section are different from each other, the torque adjusting unit changes the driving torque applied to the transfer member by the second driving unit when a leading edge of the recording medium enters the face-to-face section.

12. The image forming apparatus according to claim 11,
wherein, if the transport speed of the recording medium by the transport unit is higher than the transport speed of the recording medium by the face-to-face section, the torque adjusting unit decreases the driving torque applied to the transfer member by the second driving unit when the leading edge of the recording medium enters the face-to-face section.

13. The image forming apparatus according to claim 11,
wherein, if the transport speed of the recording medium by the transport unit is lower than the transport speed of the recording medium by the face-to-face section, the torque adjusting unit increases the driving torque applied to the transfer member by the second driving unit when the leading edge of the recording medium enters the face-to-face section.

14. The image forming apparatus according to claim 13,
wherein the torque adjusting unit decreases the driving torque applied to the transfer member by the second driving unit when a trailing edge of the recording medium passes through the transport unit after the leading edge of the recording medium enters the face-to-face section.

15. The image forming apparatus according to claim 1,
wherein the torque adjusting unit changes the driving torque of the transfer member in accordance with at least one of a basis weight of the recording medium, smoothness of a surface of the recording medium, a density of the image to be transferred onto the recording medium, an air temperature, and humidity.

16. The image forming apparatus according to claim 1,
wherein the torque adjusting unit changes the driving torque of the transfer member within a range in which a ratio of a peripheral speed of the transfer member to a peripheral speed of the image bearing member does not change.

17. The image forming apparatus according to claim 1,
wherein the first driving unit includes an outer rotor motor, and wherein the second driving unit includes an inner rotor motor having smaller moment of inertia than the first driving unit.

18. An image forming apparatus comprising:
image bearing means for retaining an image to be transferred onto a recording medium, the image bearing means being rotatable;
first driving means for rotationally driving the image bearing means;
transfer means for transferring the image retained by the image bearing means onto the recording medium passing through a face-to-face section where the image bearing means and the transfer means face each other, the transfer means rotating while facing the image bearing means;
second driving means for rotationally driving the transfer means; and
torque adjusting means for changing a driving torque applied to the transfer means by the second driving means in accordance with a position of the recording medium passing through the face-to-face section.
